(19) United States
(12) Patent Application Publication
(10) Pub. No.: US 2010/0030594 A1
(43) Pub. Date: Feb. 4, 2010

(54) Method for User Driven Multi-objective Optimization of Travel Plans

(76) Inventor: Garret Frederick Swart, Palo Alto, CA (US)

Correspondence Address: Lalitha Swart, 770 La Para Avenue, Palo Alto, CA, 94306, US

(21) Appl. No.: 12/512,023

(22) Filed: Jul. 29, 2009

(30) Foreign Application Priority Data
Jul. 29, 2008 (US) 61084380

(51) Int. Cl. G06Q 10/00

(52) U.S. Cl. 705/6

(57) ABSTRACT

The invention is a travel planning system that treats travel planning as a multi-objective optimization problem and allows the one or more users to optimize itineraries through an iterative process of selecting new destinations by a greedy process that encourages the adding of destinations that taken one at a time add minimally to the cost and maximally to the benefit of the itinerary and a competitive process of comparing potential itinerary changes on multiple benefit axes.

### BACKGROUND

Planning is a complicated but necessary process for a traveler trying to make the best use of limited time, money and energy. A good plan meets the traveler's goals while being realistic and efficient. It must provide for travel time and down time, time to see the attractions and time to relax. Existing computer aided travel tools help when planning a flight or booking a car or hotel, or provide reviews of attractions, area, and hotels, but they do not help when planning the actual content of the trip: deciding where to go, where to break journey for the night, what to see and when to see it—and doing this all within the context of the traveler's time, money, travel mode, lodging and energy constraints. This type of planning requires information unavailable in most databases and requires knowledge of the traveler heretofore unexploited by computer aided tools. Planning is important. For example, a traveler may choose an attraction but plan a visit when the attraction is closed. By determining this during the planning process, the problem can be detected and remedied. The remedy may mean simply adjusting the time of the visit or it may involve rearranging the trip itself. A trip planned to include two days in Paris and then two days in London might work better if the traveler visits the cities in a different order, visiting London on Monday and Tuesday and Paris on Wednesday and Thursday avoiding Paris on Monday and Tuesday when many of its attractions are closed.

Giving travelers this kind of planning help requires lots of information. While the opening hours and travel times between locations are available on the web, they are generally available only as unstructured textual information, not in a structured format that can be understood by planning tools. Even with the appropriate information, constraints solving and optimization must be incorporated into interactive process of travel planning usable by regular people.

The current state of the art is for travelers to arduously collect this information and apply it manually to potential itineraries, or take their chances traveling without a plan. Most choose the latter simply because the planning process is so arduous. Logistics have been used in military and industrial planning for centuries and has fostered the disciplines of Operations Research and Mathematical Optimization addressing problems such as how to best pack a transport plane, or where to build a factory so as to minimize transportation costs. The Traveling Salesman problem, probably the most famous optimization problem, is that of planning the cheapest route for a salesman to visit a set of cities and it is a problem in travel logistics. In this invention we show how to apply logistics and optimization to travel planning.

### DESCRIPTION

The present invention relates to Logistics Based Travel Planning. People plan their leisure travel in very different ways. Some people plan a minute by minute schedule and try and arrange everything in advance, others buy their plane ticket and leave everything else up to chance. The challenge in developing travel planning software is to add value to the travel experience for a wide variety of travelers, covering a wide range of personality types.

No matter the type of traveler, most have experienced the frustration that comes from arriving at a museum on the one day in the week it is closed, or missing a free music festival a few blocks from where you were walking, or spending too much time and money on transportation because of a poorly located hotel. These are all problems in travel logistics, that is, they are problems caused by not optimizing the activities and resources to maximize the enjoyment of the travel experience.

Logistics have been used in military and industrial planning for centuries and has fostered the disciplines of Operations Research and Mathematical Optimization addressing problems such as how to best pack a transport plane, or where to build a factory so as to minimize transportation costs. The Traveling Salesman problem, probably the most famous optimization problem, is that of planning the cheapest route for a salesman to visit a set of cities and it is a problem in travel logistics. However logistics as a discipline has not been applied to leisure travel planning.

One of the reasons these types of tools have not been applied to leisure planning is that the objective function for leisure travel is less clear. In optimization, the objective function is what is being optimized for. It might be maximizing profits or one of its indicators such as time to market, market share, sales calls made, or expenses. In leisure travel, the objective function is much less tangible and the users of the system are typically unable to express it in a meaningful way.

For leisure based travel we assume that we are finding an itinerary, a list of the destinations to be visited with optional times associated with these visits. Destinations can include any place the user wants to visit such as: countries, regions, cities, towns, attractions, hotels. From inside the space of possible itineraries, we are searching for the itinerary that has the best values for an objective function. This objective function is a complex combination of the following objective functions:
(1) User interest in each destination or event, where an event is a visit to a destination at a particular time: based on the user's own proclivities.
(2) Objective interest in each destination or event: based on an expert's assessment or the consensus of some group.
(3) Travel time: Time spent traveling where the travel mode is not of intrinsic interest, or where the time on a particular mode of travel exceeds a threshold. E.g. The first trip on the Paris metro is an experience, the tenth is a chore.
(4) Travel Expenses: travel to and from a destination, hotel costs, dining costs, entrance fees, tickets, and currency conversion costs.
(5) Comfort: When planning leisure travel, enough free time has to be scheduled to explore and experience the destination or the attraction, taking a break in a cafe, or dawdling in a boutique. Comfort can also be increased by or staying in a special hotel, touring with a private guide, or being met at the airport.

The combination of these objectives is certainly different for each person or for the same person on different trips or even on different days in the same trip.

The other reason that optimization techniques have not been applied in the leisure travel domain is that evaluating the objective functions require a large amount of master data about each of the destinations and travel between those destinations. The problem of collecting and maintaining this master data is not addressed in this application.

It is in this multi-objective environment that we apply the iterative user driven optimization process described here. The first part is an iterative multi-objective greedy optimization that puts the information in front of the user so that immediate ramifications of each new destination are exposed, for each of the objective functions. The second is a set of automated efficiency experts that periodically give suggestions to the user on how to re-optimize the past choices based on the objectives that are most important to the user. By applying these two phases iteratively we allow new decisions to be made and old decisions to be reconsidered in an intuitive way and without having the user attempt to describe their personal objective function.

Multi-Objective Greedy Optimization

Greedy is a term that is used for an optimization process that proceeds in each step by evaluating each option independently and choosing the option that most improves the current value of the objective function. Greedy processes are very efficient but not necessarily optimal, as there is no “look ahead” at the ramifications of a decision or reconsideration of the consequences of the decision. Consider a vacationer who decides which attractions to see by at each step choosing to see the unseen attraction closest to his or her current position. Such a path may be quite inefficient compared with a plan made by choosing a set of attractions and planning an optimal route through those attractions.

Through the use of this invention we mitigate the negative consequences of greedy optimization in two ways. One is the optimization experts described below that allow for post facto optimization, but the first takes place in the Greedy phase itself, and that is to rely on the user's intuition and to allow the user to easily choose not only among the highest rated options for each objective, but from a variety of high quality options for each of the objective functions and with a small effort, an arbitrary decision.

Multi-Objective Competitive Experts

Competitive algorithms are often used in optimization in an attempt to blend the behavior of a set of algorithms each of which has its own, hard to determine, sweet spot. Each of the algorithms is given a portion of the systems resources and come back with a solution. At the end of each step, a control program chooses the best approach so far, reassesses the resource allocation, and starts the algorithms using the latest state from the algorithm that did the best last time.

In the leisure travel environment we don't have a single objective function, instead we let the user drive the optimization, the user is presented with the results of a set of automated single objective experts, each of which, taking the existing itinerary, and report the most important small set of changes to the schedule that make the most sense given the objective and given the existing schedule. The user can then browse each of the changes proposed, see the consequences of making the change, and determine which one to apply. The user iterates on this, applying changes to the schedule, until the user decides that enough optimizations have been done, at which point the user can go back into Greedy mode, for adding in new destinations.

Formal Treatment

Let D be the set of destinations. An itinerary is a list of these destinations with optional times, if T is the set of times and s is the null symbol, then we can represent the set of itineraries, S, as (D x (T □ e))*. where * is the Kleene closure operation on strings, x is the Cartesian product and e is the empty string.

We start with a vector of objective functions r, each mapping itineraries in S into cost values in the real numbers, that is the vector r consists of elements, ri: S→R. The multi-objective greedy optimization problem is, given an itinerary s, to find the destinations di that optimizes its respective objective function, that is, find di where ri(s . di) has its optimal (maximal or minimum) value.

The multi-objective competitive change problem is different. In this problem we again start with an itinerary s, and for each objective function ri we find the change to that itinerary ci: S→S, that most improves the value of the associated objective function, that is ri(ci(s)). In order to limit the problem we limit the change functions that we will consider to be small numbers of destination order swaps and deletions.

The competitive problem is a more difficult problem to solve because the space of change functions can be much larger than the number of reasonable new destinations. This is one reason we solve the competitive change problem as part of an explicit user request, rather than the greedy optimization, which we can solve fast enough to use as part of the user interface.

Result Spacing

Many optimization problems, while they may have only one truly optimal answer, have several “nearly optimal” answers where the objective function may be close enough to the optimal value so that the user may wish to use other criteria to choose between the answers rather than the insignificantly small changes in the objective function. The difficulty with presenting these “near optimal” answers is that many cases the nearly optimal answers cluster together and given we want to show a small number of answers, we want to display the best representative answer in each cluster, not simply the best answers defined by the objective function. One way of doing this is to think of the optimization problem as producing a vector of results where the results need to be spaced out to avoid presenting many nearly identical suggestions.

For the multi-objective competitive change problem defined above, we can define a metric on the change space, and for each objective function ri find the vector of changes Ci=(c1, . . . , cn), so that the average savings per change, given by, Zj ri(s)−ri(cj(s))/|Ci| times the change diameter maxi, j d(ci, cj) is maximized. As long as |Ci| is small, then this objective function yields a wide variety of distinct solutions.

Itinerary Collaboration and Coordination

The simplest model of itinerary building is that of a single user building an itinerary for one or more travelers who will move together as a group between destinations. This is the way that a family might arrange their travel. However, when a group of friends are collaborating on a trip they will take together or when arranging for a conference or a wedding, where many people will have separate itineraries, this simple model starts to break down. There are two independent ways that we can generalize this simple model. One way is by opening up the decision making process to more than one person and using the computer to mediate the collaborative process The other way is by producing multiple coordinated itineraries for a group that may want to visit some destinations together, but visit other destinations in smaller subgroups. These two approaches can be used together, allowing a collaborative process for building a multi-track itinerary. Itinerary Collaboration is supported in one of two ways:
(1) Coordinated: There is a single itinerary coordinator. This coordinator can send other users, or outside experts, proposed itineraries, and the other users can make annotated suggestions for changing the itinerary. The coordinator receives the advice and incorporates any part of the advice the coordinator wants to incorporate and may send out the updated itinerary.
(2) Peer to Peer: In this collaboration scheme each user makes their own itinerary either from scratch or by incorporating pieces of other user's itineraries. User's with similar itineraries are clustered and presented with tools to merge their itineraries. The process continues until the users stop merging itineraries, presumably when the entire group has a single itinerary.

Itinerary Coordination is supported through an alternation operation. A simple itinerary consists of destinations separated by a “sequencing” operator. A Coordinated Itinerary can consist of a destinations separated by sequencing and alternation operators. An individual itinerary is chosen from the coordinated itinerary by choosing, top down, an alternative for every alternation.

Examples of the following (a set of automated single objective experts, each of which, taking the existing itinerary, and report the most important small set of changes to the schedule that make the most sense given the objective and given the existing schedule):

Single objective experts might include:
(1) Travel time minimizer:
   (a) Rearranges the order in which destinations are visited in order to reduce the amount of time spent traveling. E.g. If the current itinerary has you visiting an out of the way suburb twice on two different days to see two different attractions, this expert will have you visit both sites on the same day.
   (b) Rearranges the order in which destinations are visited to ensure that the maximum number of destinations and events are available to the user for their itinerary E.g. for a trip to Paris and London, if Paris attractions are largely closed on Monday and Tuesday but London attractions are largely open, this expert would rearrange your trip, including flights, hotels and local attractions to spend Monday and Tuesday in London and Wednesday and Thursday in Paris.
   (c) Changes the travel mode in order to reduce the amount of time spent traveling. E.g. If the current itinerary has getting to the out of the way suburb by bus, this expert might change the travel mode to rail or taxi to save time.
   (d) Suggest removing an attraction that is not highly weighted and is all alone in an out of the way suburb.
(2) Cost minimizer
   Rearranges the order in which attractions are visited to reduce the amount of money spent on travel. (Same example as above.)
   Changes the travel mode to save money, e.g. changing from taxi to bus, or tax to rental car.
   Suggests removing a destination that is expensive to get to, or has very high fee.
   Replaces one destination with another to reduce the overall costs
(3) Elapsed time minimizer
   All the travel time minimizations but with the goal of minimizing the length of the entire trip.
   Attempt to pack more attractions into a day
   Reduce time spent at attractions to the minimum rather than the suggested.
(4) Relaxation maximizer
   Spread out attractions evenly over all days to maximize the amount of “down” time in each day.
   Reduce the number of connections between travel modes. E.g. One longer bus ride might be preferable to two trains and a subway even if the latter is shorter or cheaper.

Start with a vector of objective functions r, each mapping itineraries in S into cost values in the real numbers, that is the vector r consists of elements, ri: S→R. The multi-objective greedy optimization problem is, given an itinerary s, to find the destinations di that optimizes its respective objective function, that is, find di where ri(s . di) has its optimal (maximal or minimum) value.

Consider the 4 objective functions optimized by each of the 4 experts given above. In this case the vector r has four elements, r1 being travel time, r2 being cost, r3 being overall time, r4 being minimum daily down time. For this problem we are looking for destinations/attractions d1, . . . , d4, (We should be consistent and use attraction instead of destination.) to add to the itinerary that optimizes each respective objective function. For example:
d1 is an attraction next to an attraction already on the itinerary because that can be added without increasing the travel time.
d2 is an attraction that can be gotten to cheaply and that is cheap to visit.
d3 is an attraction that can be fit into a free slot in a day, e.g. an attraction that is open in the evening.
d4 is an attraction that can be fit into a day that already has plenty of down time.

Start with an itinerary s, and for each objective function ri we find the change to that itinerary ci: S→S, that most improves the value of the associated objective function, that is ri(ci(s)). In order to limit the problem we limit the change functions that we will consider to be small numbers of destination order swaps and deletions.

This is as above but instead of just adding an attraction we are making a change c=(c1, c2, c3, c4). For example:
c1 is a function that rearranges the itinerary to visit the out of the way suburb only once.
c2 is a function that changes the travel mode from taxi to bus.
c3 is a function that moves all the attractions visited on day 4 into days 1, 2 and 3, so you can go home early (or move on to the next city on your schedule earlier).
c4 is a function that moves the Louvre and the Musee D'Orsay to separate days to give you more time to relax

A simple itinerary consists of destinations separated by a “sequencing” operator. A Coordinated Itinerary can consist of a destinations separated by sequencing and alternation operators. An individual itinerary is chosen from the coordinated itinerary by choosing, top down, an alternative for every alternation.

A simple itinerary consists of destinations composed using a sequencing “do” operator “.”, e.g. (9 am Louvre . 11 am Musee D'Orsay . 1 pm Lunch at Taillevent . 3 pm Eiffel Tour). A coordinated Itinerary allows for alternation as well, allowing individual travelers to make choices. E.g. A itinerary might allow travelers to choose between the very expensive Taillevent and the cheaper Citrus Etoile and between the strenuous Eiffel Tour and the more sedate Napoleon's Tomb. This can be expressed using an alternation operator as (9 am Louvre . 11 am Musee D'Orsay . (1 pm Lunch at Taillevent|Lunch Citrus Etoile) . (3 pm Eiffel Tour|Napoleon's Tomb).
A plurality of objective functions that can be calculated on an itinerary Going back to the running example, the vector r=(r1, r2, r3, r4) is an example of a plurality of objective functions which calculate the travel time, cost, total time and minimum daily down time respectively.

### DRAWING DESCRIPTION

FIG. 1: is an illustration of the preferred embodiment of web based itinerary Optimization System.

FIG. 2: is an illustration of the user guided multi objective Greedy attraction insert procedure.

FIG. 3: is an illustration of the user guided multi objective Itinerary optimization procedure.

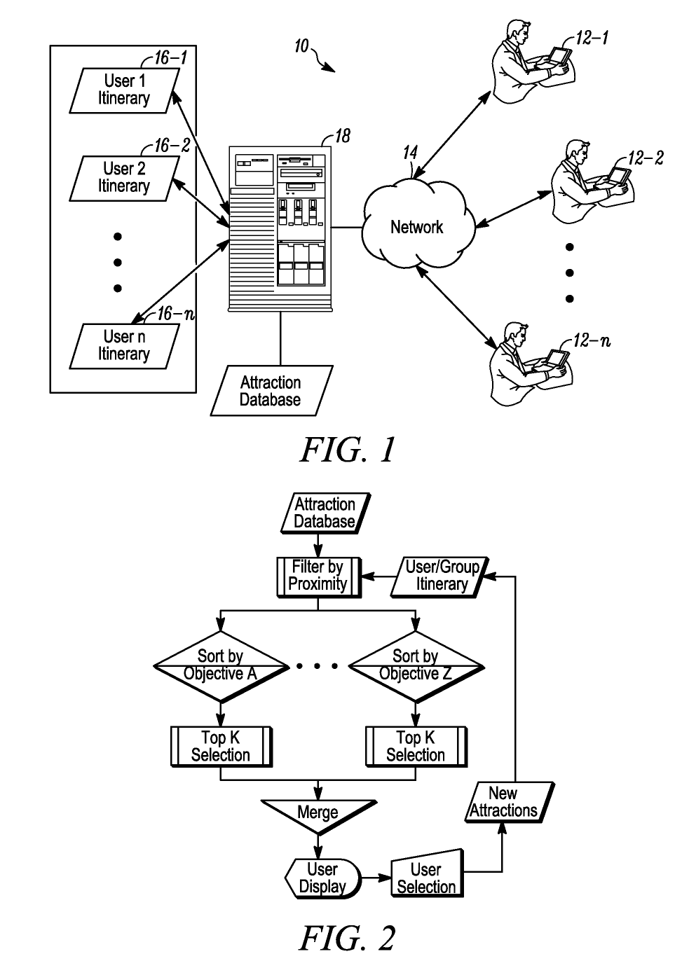

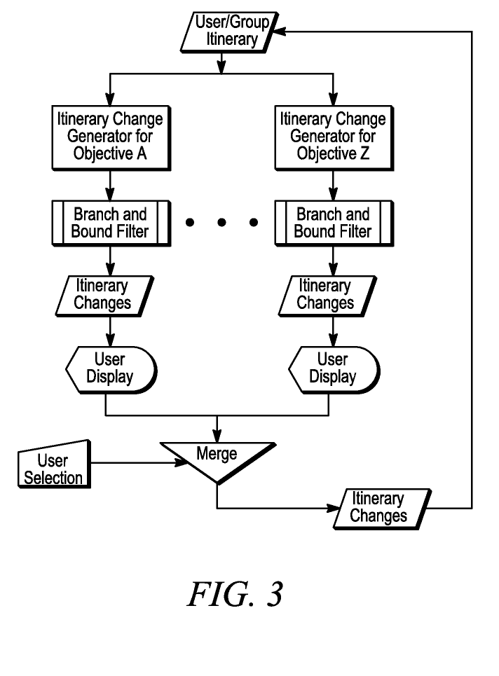

### NUMBER DESCRIPTION LIST

10: is the overall invention of logistics based travel planning.

12: are the travelers.

14: is the network.

16: are the different objectives.

18: is the server.

1. A travel planning system comprising (a) mutable itinerary, an itinerary comprising a list of events where each event is composed of a destination with an optional time interval. (b) A plurality of objective functions that can be calculated on an itinerary. (c) A multi-objective greedy optimization process wherein for each potential additional destination the user is presented with the effect of adding that destination to the itinerary on each objective function. (d) A multi-objective competitive optimization process wherein for each objective function an automated optimization algorithm makes suggestions as to how to improve its objective function by suggesting changes to the itinerary.

2. A travel planning system, as in claim 1, where the objective functions used in the optimization processes include one or more of the following: (a) User interest in each destination or event: based on the user's own proclivities. (b) Objective interest in each destination or event: based on expert's assessment or the consensus of some group. (c) Travel time: Time spent traveling between destinations where the travel mode is not of intrinsic interest, or where the time on a particular mode of travel exceeds a threshold. (d) Travel Expenses: Including entrance fees, tickets. Comfort: As measured in free time in the schedule. (e) Comfort can also be increased by or staying in a special hotel, touring with a private guide, or being met at the airport.

3. A travel planning system, as in claim 1, where each automated expert may present a set of well spaced itinerary optimizations instead of a single “best” value.

4. A travel planning system, as in claim 1, where the suggestions made by using a single objective automated expert are evaluated using all available objective functions for purposes of aiding the user in deciding between the results.

5. A travel planning system, as in claim 1, where the set of possible changes in the itinerary are a limited number of instances of: (a) Deleting a destination, (b) Changing the positions of two destinations, (c) Adding or removing a specific time to a destination.

6. A travel planning system, as in claim 1, where the users by collaborate by sending actionable comments on an itinerary containing a sequence of change as specified above, to the itinerary owner, that is the user that last modified the itinerary.

7. A travel planning system, as in claim 1, where the users collaborate through repeated pair wise merging of itineraries.

8. A travel planning system, as in claim 1, where the itinerary has been extended to include alternation, a choice of plans to be attended over a particular time commitment.

9. A travel planning system, comprising claims 7 and 8, and where the merging used in claim 7 has been extended to include the alternation operator from claim 8.
